(19) United States
(12) Patent Application Publication
(10) Pub. No.: US 2014/0278618 A1
(43) Pub. Date: Sep. 18, 2014

(54) RELATIONSHIP MAPPING SYSTEM, METHODS, AND TECHNIQUES

(71) Applicant: IntellectSpace Corporation, Seattle, WA (US)

(72) Inventor: Aleksandr Gvelesiani, Bothell, WA (US)

(73) Assignee: IntellectSpace Corporation, Seattle, WA (US)

(21) Appl. No.: 14/205,315

(22) Filed: Mar. 11, 2014

Related U.S. Application Data
(60) Provisional application No. 61/785,034, filed on Mar. 14, 2013.

(51) Int. Cl. G06Q 10/06

(52) U.S. Cl. CPC G06Q 10/063
USPC 705/7.11

(57) ABSTRACT

Methods, techniques, and systems for relationship mapping are provided. Example embodiments provide a Relationship Mapping System RMS, which provide information to enable users to learn about relationships. Example embodiments provide a Relationship Mapping System (“RMS”), which enables users to perform business development, fundraising or other related activities. The RMS comprises software algorithms, a software application, and a database system that can be deployed on the premises of one Party, or be configured and made available via the Internet or other communications wide area network as a Software-as-a-Service (SaaS) application to multiple unrelated Parties.

### TECHNICAL FIELD

The present disclosure relates to methods, techniques, and systems for relationship mapping and, in particular, to methods, techniques, and systems for mapping professional relationships for purposes of supporting business development, fundraising, or other related activities

### BACKGROUND

Many organizations and professionals (“Parties”) who are engaged in business-to-business commerce constantly look for ways in which they can leverage their existing professional networks to reach and engage prospective business opportunities (i.e., the organizations and/or professionals referred to herein as “Counterparties”). To achieve this, Parties often conduct detailed research about the professional relationship networks of each of their Counterparties. In order to identify efficient ways to reach and engage them, Parties often analyze their own professional networks in order to determine whether they share any mutual connections with business opportunities that they wish to develop. For the purpose of this description, this process will be referred to as “Relationship Mapping.”

The principles of Relationship Mapping have been applied to a wide range of professional activities, including but not limited to sales, business development, fundraising, investor relations, prospect development, marketing, channel development, competitive intelligence, and business intelligence. Although the benefits of leveraging existing professional relationships to develop new business opportunities have been well documented, the sheer volume of information involved and a lack of automated techniques have rendered the process of Relationship Mapping as manual, laborious and often incomplete.

### BRIEF DESCRIPTION OF THE DRAWINGS

FIG. 1 is a block diagram illustrating example components of an example Relationship Mapping System.

FIG. 2 is an example block diagram illustrating example tables used in the one or more databases of the Relationship Mapping System.

FIG. 3 is an example flow diagram of the logic of the Relationship Mapping System for populating Relationships and calculating Connections.

FIG. 4 is an example flow diagram of the logic of the Relationship Mapping System for calculating paths between multiple Persons.

FIG. 5 is an example block diagram of a computing system for practicing embodiments of a Relationship Mapping System.

### DETAILED DESCRIPTION

Embodiments described herein provide enhanced computer- and network-based methods, techniques, and systems for Relationship Mapping. Example embodiments provide a Relationship Mapping System (“RMS”), which enables users to perform business development, fundraising or other related activities. The RMS comprises software algorithms, a software application, and a database system that can be deployed on the premises of one Party, or be configured and made available via the Internet or other communications wide area network as a Software-as-a-Service (SaaS) application to multiple unrelated Parties. Each Party using the RMS will be referred to as a “Group.” Each Group has one or more users with access to the RMS (“Users”) which may be individuals or systems providing electronic access.

In one example embodiment, the RMS comprises one or more functional components/modules that work together to provide Relationship Mapping. FIG. 1 shows several components of an example Relationship Mapping System. The RMS consists of a Database 102, an RMS Algorithm 104 and an RMS Application 103. For example, an RMS 100 may comprise one or more databases 102 (individually or collectively referred to as “Database”) for storing information about individuals (“Persons”) and other entities (referred to as “Organizations”) and methods for manipulating the information stored in those databases. The Persons and Organizations may be of the following nature (or similar):
companies
business units
nonprofit organizations
association
social clubs
business transactions
events
government agencies
   Persons and Organizations herein are individually referred to as an “Entity” and collectively as “Entities.”

FIG. 2 shows some of the tables that are stored in the Database 102 of FIG. 1. Other tables may also be included in other embodiments of the RMS. The RMS Algorithm 104 analyzes the Entities and Relationships stored in Database 102 in order to derive and store Connections in the Database. The RMS Algorithm 104 also calculates Paths for the RMS Application 103 based on requests received and data in the Database 102. The RMS Application 103 provides an interface to the Database 102 and the RMS Algorithm 104, which is used to both read and populate data into the Database 102, either manually or automatically.

In example, Relationship Mapping Systems, the Database (such as Database 102 in FIG. 1) stores the existence of current or past relationships among Entities, and detailed information of each of such relationships (referred herein as “Relationship”). Some examples of Relationships include but are not limited to the following relationships:
board member
c-suite executive
senior executive
mid-level manager
investor
acquisition
partnership
employment
contractor
advisor
trustee
donor
family
professor
student
attorney
financial advisor
donation/contribution

For example, one Relationship might be a past senior executive position between a Person and an Organization during a four-year span during the years of 2004 and 2008. The Entity and Relationship information need not be directly or indirectly related to Groups or Users; instead, they are manually or automatically added into the Database for a select group of Persons and Organizations for a particular domain (“Data Coverage”). Depending on the use or purpose, Data Coverage might be as broad as all executives in companies and nonprofits registered in the United States, or as narrow as board members of publicly traded companies in the United States. Persons and Organizations stored in the Database are uniquely identifiable and not duplicated.

One use of the RMS, for example, might require the Data Coverage of all publically traded companies in the United States and their board members. In this example, the Database would be populated with Person records, each of whom is a board member of each publicly traded company, along with each of his or her current and past Relationships to his or her respective public companies and other Entities. If any Person is related to multiple public companies, such as a person sitting on two public company boards, then one unique Person record would be stored in the Database, along with multiple Relationship records connecting the Person to multiple public company Organization records, along with all other Entities to which that the Person is (or was) affiliated.

In some example RMSes, the Database stores, calculates, or derives, in real time (or near real time), information regarding determining the Persons that know each other by analyzing their mutual Relationships (“Connections”) to the same Entities. The Connections can either be explicitly entered into the Database by authorized users or derived automatically based on an analysis of mutual Relationships that each Person shares with other Persons. This analysis may include the nature of mutual connections shared, number of mutual connections shared, and the locations of Persons and their mutual connections. For example, the RMS may deduce or derive that Person A is Connected to Person B after analyzing each of his or her Relationships to the same Entities, during a same time period, and in the same location. Another example might be one in which a User has explicitly added to the Database the fact that Person A is Connected to Person B. The RMS may include a strength indicator when calculating and/or storing Connections in the Database. The strength indicator could be either an explicit classifier such as (Low, Medium, and High), a point system such as (772 Points) or a percentage of strength, such as (93% Strength), or the like.

In addition to storing information about People and Organizations, the Database stores information about each Group that is benefiting from the RMS, as well as information about its authorized Users. Multiple Users may be part of the same Group using the RMS. Each User has the ability to see the information stored about other Users in the same Group (referred herein as “Colleagues”).

The Database stores information about which Persons each User and/or Group is/are connected to, along with the nature of such connections, as a Contact record (referred herein as “Contact”). For example, one User might have identified and stored 20 Persons as his or her Contacts. In this example, Contact records are created in the Database which stores connections between the User, the Group, and the Person in the Database. In another example, 30 Persons may be identified as the Group's Contacts that are shared across all Users within the Group. In this example, a Contact record is created between the Group and each of the 30 Person records in the Database. When a Contact record is created between a Group and a Person, the Contact record points to the Person record. It is possible for multiple Groups to have Contact records that are pointing to the same Person record.

The RMS allows for Contacts to be grouped into multiple categories (as “Category”) at the discretion of Groups or Users using the invention. Each Contact can be assigned to zero, one, or multiple Categories, and each Category can have zero, one, or multiple Contact record relationships in the Database. Each Category can be specific to a particular User, or shared across a Group.

The RMS also allows for Users or Groups to identify and store Persons whom the User or Group wants to reach as a prospect (“Prospect”). More specifically, the RMS stores information about which Persons each Group or User wants to reach as a Prospect record, along with the nature of these relationships. Similarly to Contacts, Prospect records relate to Person records and can also be assigned to Categories. To minimize the duplication of logic between Contact and Prospect records, the RMS allows for Prospect records to be stored in the same Database tables as Contacts, but in a manner that distinguishes Prospects from Contacts by adding one more flag to the Contact record, such as an IsProspect field. However, the RMS may use a dedicated Prospect table to store Prospects, should that approach be more appropriate for the intended use of the RMS.

In addition to storing Prospects, the RMS allows for a User or a Group to identify Organizations it wants to reach, and store them as “Target” records. This can be useful if a Group or User wants to reach a particular business entity without knowing which person in particular to target. Target records will be created in the Database, each of which will point to a User or Group record, and each of the Organization records. The RMS allows for Target records to be categorized under Categories in a similar manner to Contacts and Prospects.

The software application (or equivalent firmware or hardware implementation) of the RMS (the “Application”) gives Users an ability to search for Persons or Organizations in the Database and view profile information (“Profile”) about them. The searches can be conducted on an ad hoc basis by name or by other fields (such as stock symbol or industry). From the search results or Profile views, a User can save Person and Organization records as Contacts, Prospects or Targets, and assign Categories to them. The Application provides the User with an easy means of viewing a list of all of its (or its Colleague's) Contacts, Prospects and Targets that the User is authorized to see. By navigating to a particular Contact, Prospect or Target record, the User will also see the Profile view of the underlying Person or Organization.

The software (or equivalent firmware or hardware implementation) algorithm of the RMS (referred herein as “Algorithm,” “RMS Algorithm,” or techniques) automatically calculates relationship paths (referred to herein as “Paths”) from one or more Persons to one or more Persons in the Database. One example RMS Algorithm 104 is shown in FIG. 1. All Path calculations require an origin and a destination. Path origins and destinations can either be a Person, an Organization, a User, a Group, Prospects, Targets or a Category. Paths can be calculated between one-to-one, one-to-many, or many-to-many Persons. One-to-one Path calculation requires both the origin and the destination to be explicit Person records from the Database. When an Organization, a User, a Group, Prospects, Targets or a Category is provided as the Path origin or destination, then Persons related to them are used as the origin or destination. If an Organization is specified as the Path origin, then all Persons who have a Relationship to the Organization are used as the Path origin in the calculation. If the User is provided as the Path origin, then all Persons who are Contacts of the User, all Persons who are Contacts of the User's Group, and all Persons who are Contacts of the User's Colleagues are used as inputs. In the previous example, if the Category of Targets is specified as the Path destination, then all Persons who have Relationships with Organizations saved as Targets are used as destinations in the Path calculation. Tables 1 and 2 below shows all Path calculation combinations:

TABLE 1

| Path Origin | Person Records Used as Origins in Path Calculation |
|---|---|
| Current User | Person records related to the current User's Contacts |
| | Person records related to the current User's Group's |
| | Contacts |
| | Person records related to the current User's Colleagues' |
| | Contacts |
| Selected User | Person records related to the selected User's Contacts |
| in Group | |
| Current Group | Person records related to the current User's Group's |
| | Contacts |
| | Person records related to the current User's Colleagues' |
| | Contacts |
| Person | Selected Person |
| Organization | Person records related to the selected Organization |
| Contact | Person records related to the Contacts in the selected |
| Category | Category |

TABLE 2

| | Person Records Used as Destinations in Path |
|---|---|
| Path Destination | Calculation |
| Person | Selected Person |
| Organization | Person records related to the selected Organization |
| Contact Category | Person records related to the Contacts in the Selected |
| | Category |
| All Prospects | Person records related to all Prospects in a particular |
| | Group |
| All Targets | Person records related to all Organizations that are |
| | saved as Targets in a particular Group |
| Prospect Category | Person records related to all Prospects in a particular |
| | Category |
| Target Category | Person records related to all Organizations that are |
| | saved as Targets in the selected Category |

A single Path calculation may yield multiple results. Each Path represents a unique set of Connections between Persons in Origin and Destination. An example of a single path between Person A and Person B may be:
Person A [symbol] Person B
Person A [symbol] Person C [symbol] Person B
Person A [symbol] Person D [symbol] Person E [symbol] Person B

For example, a Path calculation between the current User and a specific Person A, where the current User has three Contacts, may yield multiple Paths, each representing different ways to reach that Person. In this example, the Path calculation will analyze the current User's Contacts and all Contacts stored in the Current User's Group in order to find Paths to the specified Person. This Path calculation may yield multiple Paths from each of the Contacts of the User and each of the Contacts of the User's Colleagues. An example of multiple results from such a Path calculation might be as follows:

1. Current User [symbol] Person A

2. Current User [symbol] Contact B [symbol] Person A

3. Current User [symbol] Contact C [symbol] Person A

4. Current User [symbol] Colleague X [symbol] Contact B [symbol] Person A

5. Current User [symbol] Colleague X [symbol] Contact C [symbol] Person A

6. Current User [symbol] Colleague Y [symbol] Contact D [symbol] Person A

Every Path calculation determines the overall strength of each resulting Path in order to highlight and show the strongest Paths first. For example, Path #2 might be a stronger Path than Path #3, and be displayed in a manner that shows the strongest Paths first.

The Paths are presented both in visual and textual manners in a way that allows the viewer to understand the nature of each Path, relative strength of each Path, strength of its underlying Connections, and details about each Connection. Connection details provide information about how two Persons know each other by showing one or more companies, position, affiliations, events and/or locations that they currently or historically shared. Visual and textual indicators may include, for example, color, shape, font, highlights, adjacent symbols, icons, or other types of indicators or emphasis.

The RMS Application provides a dedicated user interface for the User to conduct Path calculations of the various kinds described herein. The Application also allows the User to see Paths from itself to a particular Contact, Person, or Organization from the Profile view of the Person or Company record. In other embodiments, an application programming interface (“API”) is provided to access the data stored in the Database, as well as information about the People, Organizations, Entities, Relationships, Categories, Paths, and the like.

The following explanation provides one example of how the RMS (such as RMS 100 in FIG. 1) might be used. A system administrator interfaces with the Application and begins populating Person, Organization and Relationship records in the Database for the intended Data Coverage. The Algorithm repeatedly (for example, on an hourly, nightly, daily, weekly, or similar basis) analyzes Relationships between Person and Organization and derives Connection records between People Records, which it stores in the Database. Connections between people and their organizations form affiliations. XYZ Corp has one professional, Jack Brown, who would like to use the RMS. A Group record and one User record is created for Jack in the Database to provide XYZ Corp's professionals with authorized access to the RMS. Jack gains access to the Application and searches for and views the Profile of Sally Jones, VP of Acme Corp—a Person whom Jack knows. Jack finds Sally in the Database and classifies Sally Jones as his Contact within the Application. Jack repeats this process and classifies other Persons in the Database as Contacts. Jack may also assign Categories to Contacts as a way to organize his network. Jack then requests the Application for a Profile view and a Path view of a Bill Smith, CFO of YYY Corp—a person whom Jack wants to reach but doesn't know what connections he might have to Jack. The Application sends a request to the Algorithm to calculate Jack's Paths to Bill Smith. The Algorithm analyzes all Connections of Jack's Contacts, determines whether any of them are directly or indirectly Connected to Bill, and responds to the Application with all direct or indirect Paths from Jack to Bill.

FIG. 2 describes example tables used to store data in the RMS

Database. The Person table 201 stores records pertaining to individuals from the Data Coverage. The Organization table 205 stores Organizations that are or have been affiliated with Persons. The Relationship table 204 stores how the Persons and Organizations are affiliated with each other. For example, if the intended Data Coverage is “board members of public companies,” then the Database will aim to store individuals who are public companies' board members as Person records. Each of their relationships to their respective public companies and other business entities will be stored the Relationship and Organization tables.

If, for example, one of such individuals to be stored were Jill White, chairperson of public company ZZZ Corp since 2003, then the Person table 201 would contain a unique record for Jill White. The Organization table 205 would contain a unique record for ZZZ Corp. The Relationship table 204 would contain a unique record representing a board member role with a position of Chairman and start date of 2003, with a reference to Jill's Person record and ZZZ Corp's Organization record. If Jill serves on other public and private company boards, is a trustee of a university, and has had an illustrious career in public service and business, then each of the entities that she has been affiliated with would be uniquely stored in the Organization table 205, and each of the roles that she held would be stored in the Relationship table 204 along with details of each such relationship. If another person, Peter Jackson, is also a board member of ZZZ Corp, then a unique Person record would be created for Peter and a Relationship record would be created representing Peter's board membership, with references to Peter's Person record and ZZZ Corp's Organization record.

The Person table 201 in the Database stores a unique identifier (“ID”) and name for each person, along with additional attributes such as age, location, and contact information. The Organization table 205 stores the ID and name of each Entity, along with other attributes, such as type, location, and website. Each Relationship record stores a reference to a Person record's ID, an Organization record's ID, and additional information about the relationship, such as the start date, end date, position, relationship type, title, location, seniority level, and whether or not the relationship is current. It is also possible for multiple Relationship records to exist between one Person and one Organization.

The Database also contains a RelationshipSummary table 206 that summarizes multiple relationships (e.g., affiliations) between any one Person and any one Organization into a single record. Data in this table is derived from the Relationship table 204 and is used for deriving Connections and calculating Paths. For example, Sally is a CEO and board member of Acme Corp, but previously she was a vice president of finance from 2003-2007 and CFO from 2007-2009. The Database stores one Person record for Sally, one Organization record for Acme Corp, and four Relationship records: CEO, Director, VP and CFO. Each Relationship record will include respective dates of each of her roles, as well as her seniority, position, title, and the nature of that role. The seniority is stored as an integer value. Her VP, CFO, CEO and Director roles with Acme Corp might be assigned 10, 20, 30, and 40 seniority roles, respectively. When a RelationshipSummary record is created for Sally and Acme Corp, Sally's four roles are summarized into one record. MinSeniority, MaxSeniority, MinDateFrom, MaxDateTo fields are used to store date and seniority ranges in the RelationshipSummary field. The RelationshipSummary record for Sally and Acme Corp would have MinSeniority of 10, MaxSeniority of 40, MinDateFrom of 2003, and MaxDateFrom of NULL to imply that at least one Relationship is still current.

The Connection table 202 in the database stores derived connections between multiple People based on their Relationship overlaps with Organizations. From the previous example, if John Brown has held a CTO role at Acme Corp since 2006, there would be Relationship and RelationshipSummary records referencing Acme Corp and John in the Database. The Algorithm would derive a Connection record between Sally and John because they both worked at Acme Corp. The strength indicator of the Connection record between Sally and John would indicate a high value because Sally and John overlapped their tenures at Acme Corp by date and seniority. If Sally and John also worked together at a different Organization, Amber Org, each would have a separate RelationshipSummary record referencing Amber Org, and the strength indicator inferring Sally's connection to John would be even higher because they overlapped with more than one Entity. If, furthermore, Sally and John had the same Location, then their Connection strength rating would be even higher because they share the same location. The Connection record stores a unique record that implies a connection between two Persons and references each Person's ID in the designated field.

Each step in the process of populating the Database occurs asynchronously, and in bulk. FIG. 3 is an example flow diagram of the logic of the Relationship Mapping System for populating the Database. The Person, Organization and Relationship tables may be continuously populated with new and updated records (block 301). The Algorithm might analyze Persons, Organizations and Relationship records in parallel to derive RelationshipSummary records (block 302). In another parallel process, the Algorithm might continuously analyze all RelationshipSummary records to derive Connection records between any two Persons (block 303). In some embodiments, the strength of each connection is also analyzed and stored. The derivation of Connection records (derived relationships) is an asynchronous process occurs ahead of requests for relationship data in order to provide near real time responses to User or Group requests for relationship mapping data (block 304).

FIG. 4 shows an example process of calculating Paths between any given Origin and Destination conducted by an example Algorithm of the RMS. The simplest form of Path calculation is one in which the request includes a reference to a Person record as the Path Origin, and another Person record as the Path Destination. The Algorithm conducting Path calculation searches all Connections records related to Persons specified as the Path Origin, and all of their Connections, recursively, and seeks any Connection record that also references the Persons specified as the Path Destination.

If the Path calculation request does not explicitly include references to Persons for Origins and Destinations, then the Algorithm identifies Persons related to the Origins and Destinations provided in the request, and uses those Persons as Origins and Destinations. For example, if the Path calculation request does provide a Path Origin, then the Person records related to the currently logged in User's Contacts and its Colleagues' Contacts are used as the Path Origin inputs in the calculation. In another example, if an Organization is used as either the Path Origin or Destination, then all Persons related to the Organization are used instead as input parameters.

Because a recursive analysis of the Connections table is required in the Path calculation, and the calculation is processed in bulk as a series of table “joins,” it is more efficient to use a ConnectionHelper table, which stores Connection record as two ConnectionHelper records, where the second record has Person references to FK_Person1 and FK_Person2 swapped. That way, recursive table joins and lookups are significantly faster and simpler.

Example embodiments described herein provide applications, tools, data structures and other support to implement a Relationship Mapping System to be used for finding connections between. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic, different logic, etc. Thus, the scope of the techniques and/or functions described are not limited by the particular order, selection, or decomposition of aspects described with reference to any particular routine, module, component, and the like.

FIG. 5 is an example block diagram of an example computing system that may be used to practice embodiments of a Relationship Mapping System described herein. Note that one or more general purpose virtual or physical computing systems suitably instructed or a special purpose computing system may be used to implement an RMS. Further, the RMS may be implemented in software, hardware, firmware, or in some combination to achieve the capabilities described herein.

The computing system 500 may comprise one or more server and/or client computing systems and may span distributed locations. In addition, each block shown may represent one or more such blocks as appropriate to a specific embodiment or may be combined with other blocks. Moreover, the various blocks of the Relationship Mapping System 510 may physically reside on one or more machines, which use standard (e.g., TCP/IP) or proprietary interprocess communication mechanisms to communicate with each other.

In the embodiment shown, computer system 500 comprises a computer memory (“memory”) 501, a display 502, one or more Central Processing Units (“CPU”) 503, Input/Output devices 504 (e.g., keyboard, mouse, CRT or LCD display, etc.), other computer-readable media 505, and one or more network connections 506. The RMS 510 is shown residing in memory 501. In other embodiments, some portion of the contents, some of, or all of the components of the RMS 510 may be stored on and/or transmitted over the other computer-readable media 505. The components of the Relationship Mapping System 510 preferably execute on one or more CPUs 503 and manage the generation and use of Relationships and other data, as described herein. Other code or programs 530 and potentially other data repositories, such as data repository 520, also reside in the memory 501, and preferably execute on one or more CPUs 503. Of note, one or more of the components in FIG. 5 may not be present in any specific implementation. For example, some embodiments embedded in other software may not provide means for user input or display.

In a typical embodiment, the RMS 510 includes one or more Software 511 (e.g., a SaaS application), one or more Algorithms 512 (e.g., the Path calculation algorithms), and Other Engines 513. In at least some embodiments, the Software 511 is provided external to the RMS and is available, potentially, over one or more networks 550. Other and/or different modules may be implemented. In addition, the RMS may interact via a network 550 with application or client code 555 that, for example, uses results computed by the RMS 510, one or more client computing systems 560, and/or one or more third-party information provider systems 565, such as purveyors of data used in the RMS data repository 515. Also, of note, the RMS data repository 515 may be provided external to the RMS as well, for example in a knowledge base accessible over one or more networks 550.

In an example embodiment, components/modules of the RMS 510 are implemented using standard programming techniques. For example, the RMS 510 may be implemented as a “native” executable running on the CPU 103, along with one or more static or dynamic libraries. In other embodiments, the RMS 510 may be implemented as instructions processed by a virtual machine. A range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously and communicate using message passing techniques. Equivalent synchronous embodiments are also supported.

In addition, programming interfaces to the data stored as part of the RMS 510 (e.g., in the data repositories 515) can be available by standard mechanisms such as through C, C++, C#, and Java APIs; libraries for accessing files, databases, or other data repositories; through scripting languages such as XML; or through Web servers, FTP servers, or other types of servers providing access to stored data. The Database 515 may be implemented as one or more database systems, file systems, or any other technique for storing such information, or any combination of the above, including implementations using distributed computing techniques. In addition, some portion of the algorithms 512 may be implemented as stored procedures, or methods attached to RMS “objects,” although other techniques are equally effective.

Also the example RMS 510 may be implemented in a distributed environment comprising multiple, even heterogeneous, computer systems and networks. Different configurations and locations of programs and data are contemplated for use with techniques of described herein. In addition, the RMS may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of an RMS.

Furthermore, in some embodiments, some or all of the components of the RMS 510 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 61/785,034, entitled “RELATIONSHIP MAPPING SYSTEM, METHODS, AND TECHNIQUES,” filed Mar. 14, 2013, is incorporated herein by reference, in its entirety.

From the foregoing it will be appreciated that, although specific embodiments have been described herein for purposes of illustration, various modifications may be made without deviating from the spirit and scope of the invention. For example, the methods and systems for performing relationship mapping discussed herein are applicable to other architectures other than a client-server architecture. Also, the methods, techniques, and systems discussed herein are applicable to differing protocols, communication media (optical, wireless, cable, etc.) and devices (such as wireless handsets, electronic organizers, personal digital assistants, tablets, portable email machines, game machines, pagers, navigation devices such as GPS receivers, etc.).

1. A method in a computing system for providing information regarding business or professional relationships between one or more parties and one or more counterparties, comprising:
on an asynchronous basis that is performed on a periodic basis,
for each of one or more types of affiliations having business or professional significance and one or more organizations, the one or more types of affiliations and one or more organizations that are part of a designated data coverage domain, determining all affiliations that fall under the one or more types of affiliation between one or more persons and the one or more organizations that are part of the designated data coverage domain;
for each such determined affiliation, populating a data repository with information that describes the affiliation between a person of the one or more persons and an organization of the one or more organizations, including an identifier of the person, an identifier of the organization, and information about the determined affiliation; and
computing a set of derived relationships between two or more of the one or more persons based upon the determined affiliations and storing the derived relationships in the data repository.

2. The method of claim 1, further comprising:
causing at least one of the set of derived relationships to be provided in response to a query for relationships between a first party and a first counterparty.

3. The method of claim 2 wherein the at least one of the set of derived relationships is provided in response to a query for relationships between the first party and the first counterparty.

4. The method of claim 3 wherein the query is a user query.

5. The method of claim 1 wherein the information about the determined affiliation includes one or more of a start date, an end date, a position, a relationship type, a title, a location, a seniority level, and/or an indicator of whether the affiliation is current.

6. The method of claim 1 wherein the information about the determined affiliation includes a strength indicator that characterizes the strength of the affiliation between the person and the organization.

7. The method of claim 1 further comprising populating a data repository with summary information that summarizes multiple affiliations between the person and multiple of the one or more or organizations.

8. The method of claim 1 wherein the periodic basis is daily.

9. The method of claim 1 wherein the periodic basis is at least one of hourly, daily, weekly, or monthly.

10. The method of claim 1 wherein the derived relationship include any relationship where a first person is indirectly related to a second based upon the determined affiliations.

11. The method of claim 1 wherein the computing a set of derived relationships between two or more of the one or more persons based upon the determined affiliations and storing the derived relationships in the data repository include computing a strength indicator that characterizes the strength of relationship between each pair of related persons of the two or more of the one or more persons.

12. The method of claim 1 wherein the computing a set of derived relationships between two or more of the one or more persons based upon the determined affiliations are computed recursively to determine all relationships emanating from a first person of the one or more persons.

13. The method of claim 1 wherein the data coverage domain indicates that the one or more organizations are at least one of publically traded companies, privately held companies, not-for profit organizations, for profit organizations, hospitals, or firms.

14. The method of claim 1 wherein the data coverage domain indicates that the one or more types of affiliations are one or more of board member, executive, manager, investor, partner, employer, employee, contractor, advisor, trustee, beneficiary donor, family member, professor, student, attorney, and/or contributor.

15. A non-transitory computer-readable medium containing content for controlling a computer processor to store information regarding business or professional relationships between one or more parties and one or more counterparties, by performing a method comprising:
on an asynchronous basis that is performed on a periodic basis,
for each of one or more types of affiliations having business or professional significance and one or more organizations, the one or more types of affiliations and one or more organizations that are part of a designated data coverage domain, determining all affiliations that fall under the one or more types of affiliation between one or more persons and the one or more organizations that are part of the designated data coverage domain;
for each such determined affiliation, populating a data repository with information that describes the affiliation between a person of the one or more persons and an organization of the one or more organizations, including an identifier of the person, an identifier of the organization, and information about the determined affiliation; and
computing a set of derived relationships between two or more of the one or more persons based upon the determined affiliations and storing the derived relationships in the data repository.

16. The computer-readable medium of claim 15 wherein the medium is a computer memory and the content are instructions stored in the memory.

17. A non-transitory computer-readable memory medium containing a data repository of relationship information, comprising:
a person table configured to provide one or more data structures that each indicate an identifier of a human being;
an organization table configured to provide one or more data structures that each indicate an identifier of an organization;
a relationship table configured to provide one or more data structures that each indicate an affiliation between a uniquely identified person in the person table and a uniquely identified organization in the organization table, wherein more than one affiliation for the same uniquely identified person and uniquely identified organization are stored as separate affiliation entries, each affiliation including affiliation information that describes the affiliation; and
a connections table configured to provide one or more data structures that each indicate a relationship derived from automatically analyzing the one or more data structures of the relationship table.

18. The computer-readable memory of claim 17 wherein the relationships indicated by the data structures of the connections table are computed by automatically analyzing the one or more data structures of the relationship table recursively to explore all indirect relationships between two or more persons.

19. The computer-readable memory of claim 17 wherein the derived relationships in the one or more data structures provided by the connections table include a strength indicator that characterizes the strength of the relationship between each pair of the two or more persons.

20. The computer-readable memory of claim 17 wherein the affiliation information includes one or more of a date, a position, a relationship type, a title, a location, a seniority level, and/or an indicator of whether the affiliation is current.

21. The computer-readable memory of claim 17 wherein the affiliation information includes a strength indicator that characterizes the strength of the affiliation between the uniquely identified person and uniquely identified organization.

22. The computer-readable memory of claim 17 wherein the affiliation between a uniquely identified person in the person table and a uniquely identified organization in the organization table is at least one of a board member, executive, manager, investor, partner, employer, employee, contractor, advisor, trustee, beneficiary donor, family member, professor, student, attorney, and/or contributor.
